(19) United States
(12) Patent Application Publication
(10) Pub. No.: US 2005/0032499 A1
(43) Pub. Date: Feb. 10, 2005

(54) Radio frequency power detecting circuit and method therefor

(76) Inventor: Jin Wook Cho, Miramar, FL (US)

Correspondence Address: Larson & Associates, P.C., 221 East Church Street, Frederick, MD, 21701-5405, US

(21) Appl. No.: 10/637,868

(22) Filed: Aug. 8, 2003

(51) Int. Cl. H04B 1/16

(52) U.S. Cl. 455/343.1

(57) ABSTRACT

A circuit for detecting the amount of radio frequency power provided by an amplifier. The circuit contains an array of coupled transistors in two power amplifiers, and a log-detector circuit, all resident on a single semiconductor die. The main power amplifier contains the larger array of transistors to amplify the radio frequency signal for feeding to an antenna, and a secondary power amplifier contains a smaller array of transistors to provide a scaled output that is proportional to the amplified radio frequency signal and is used to control the main power amplifier. The log-detector circuit converts the signal from the secondary power amplifier to a full-wave rectified log-linear DC signal that is logarithmically proportional to the controlling signal. The DC signal output from the log-detector circuit is fed to the main power amp to control it.

### FIELD OF THE INVENTION

This invention relates generally to radio frequency power amplifiers. More particularly, this invention relates to control circuitry for determining and controlling the output power provided by power amplifiers.

### BACKGROUND OF THE INVENTION

Modern mobile wireless devices such as cellular telephones, portable radios, personal communication devices, and two-way pagers operate on battery power, and in the transmit mode they can consume a significant amount of battery capacity. Although newer battery chemistries have increased the capacity of rechargeable batteries, the physical size of these electronic devices and their associated batteries continues to shrink, making battery power a precious commodity that is expensive and at times in short supply. These mobile devices generally require that a specified radio frequency (RF) output power be delivered to a radiating antenna, so rather than delivering a constantly high power at all times, some systems dynamically raise and lower the transmitted power to achieve specific performance depending on the distance from a receiving antenna. This requires sampling the output of a power amplifier or amp (PA) to create a signal, which is sent to control circuitry. The control circuitry generates a control signal that adjusts the output power of the amplifier until it is at the desired level.

A common method of sampling output power uses a directional coupler on the output of the PA to generate a signal proportional to the output voltage. Unfortunately, directional couplers also add loss, typically, about 5-10% of the PA efficiency, forcing the power amplifier to deliver more power. This places more demands on the battery, thus reducing the talk and standby time of the mobile wireless device. In addition, the cost associated with having external components (directional coupler, attenuator, etc.) makes this approach less desirable.

Another methodology is to measure the current drawn by the PA. Since the measured current is directly related to the amount of power output by the PA, it can be fed back to appropriate control circuitry to operate the PA at peak efficiency. The voltage across a series dropping element added between the battery and the PA bias input determines the current entering the power amplifier for a known resistance across the element. This technique is also disadvantageous as a tradeoff is made between reduced accuracy at lower output power using a series dropping element with small resistance and reduced efficiency using a series dropping element with larger resistance to overcome this problem Still another approach is to configure transmitters in multi-mode systems (such as those that transmit voice and data at various rates) for the application that imposes the most stringent linearity requirement on the system such as high data rate transmission This approach results in excessive operating current in the other modes of operation. Because of the excessive operating current, the battery life, and hence talk-time, of the communication device will be decreased.

Although each of these approaches seeks to reduce the power drain on the battery, none provide a solution that reduces the amount of power required by the RF front-end transmitter of a communication device.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is an electrical schematic diagram of a radio frequency power detecting circuit in accordance with certain embodiments of the present invention.

FIG. 2 is a schematic representation of a transistor array network in accordance with the present invention.

FIG. 3 is a block diagram of method of detecting radio frequency power in accordance with certain embodiments of the present invention.

FIG. 4 is an electrical schematic diagram of a radio frequency power detecting module in accordance with certain embodiments of the present invention.

### DETAILED DESCRIPTION OF THE INVENTION

The present invention relates to an efficient technique and structure for detecting transmit power associated with a power amplifier. In accordance with certain embodiments of the invention, a circuit contains an array of coupled transistors in two power amplifiers, all resident on a single semiconductor die, and a log-detector circuit. The main power amplifier contains the larger array of transistors to amplify the radio frequency signal for feeding to an antenna, and a secondary power amp contains a smaller array of transistors to provide a scaled output that is proportional to the amplified radio frequency signal and is used to control the main power amp. The log-detector circuit converts the signal from the secondary power amp to a full-wave rectified log-linear DC signal that is logarithmically proportional to a controlling signal. The DC signal output from the log-detector circuit is fed to the main power amp to control it. While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings.

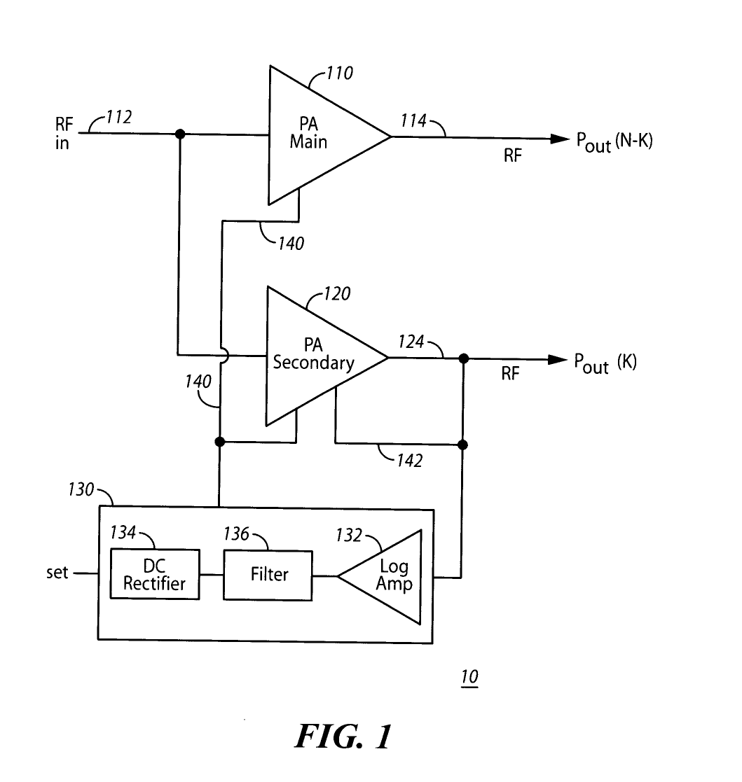

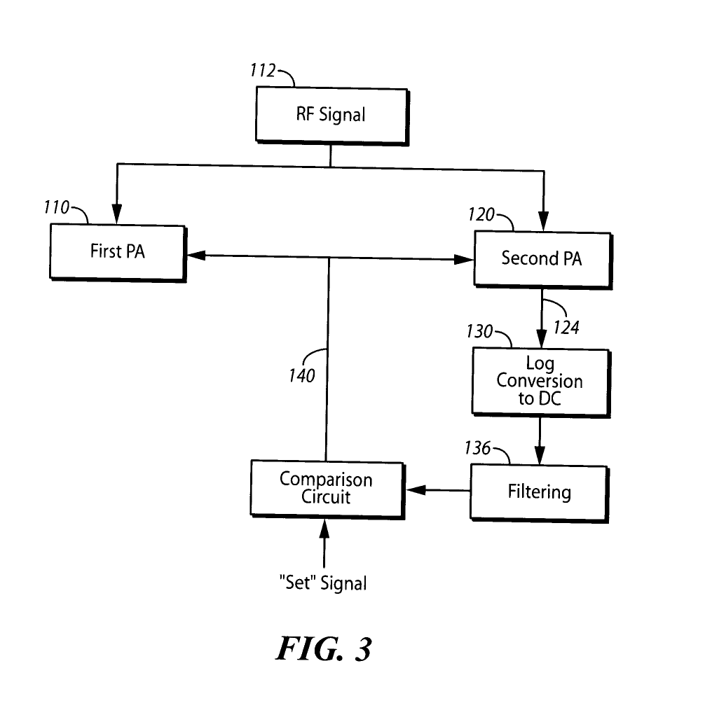

Mobile wireless devices such as cellular telephones, portable radios, wireless personal digital assistants, and two-way pagers all operate on battery power, and generally contain, among other elements, a receiver front end, a radio frequency transmitter section, an antenna, a switch (with a diplexer or duplexer), a control system, a frequency synthesizer, and some sort of a user interface. When a human user desires to send a voice or data message, the message is entered via the user interface, digitized, and encoded for transmission. The encoded data is output to the transmitter, where it is modulated into a carrier signal at a desired transmit frequency, and then amplified by a power amplifier to a selected level and delivered to an antenna. Referring now to FIGS. 1 and 3, a radio frequency power detecting circuit 10 contains a first (or main) power amplifier 110 is arranged to receive a radio frequency signal 112 and to amplify the signal to provide a first output signal 114. A second (or sampling) power amplifier 120 is also arranged to receive the radio frequency signal 112 and to provide a second output signal 124 that is substantially smaller in magnitude than the first output signal 114. The first PA contains an array of transistors arranged in a network, and the second PA likewise contains an array of transistors arranged in a network, but may also simply have a single transistor. All the transistors are on a single semiconductor die, and are considered to be in a network containing a total of N transistors, where the second PA contains K transistors and the first PA contains (N-K) transistors. The transistors N are heterojunction bipolar transistors (HBTs) formed on a single semiconductor die and equally sized to form a transistor array. However, other types of transistors such as bipolar junction transistors (BJT), field effect transistors (FET), etc. can be used on various types of substrates such as silicon, gallium arsenide, germanium, etc.

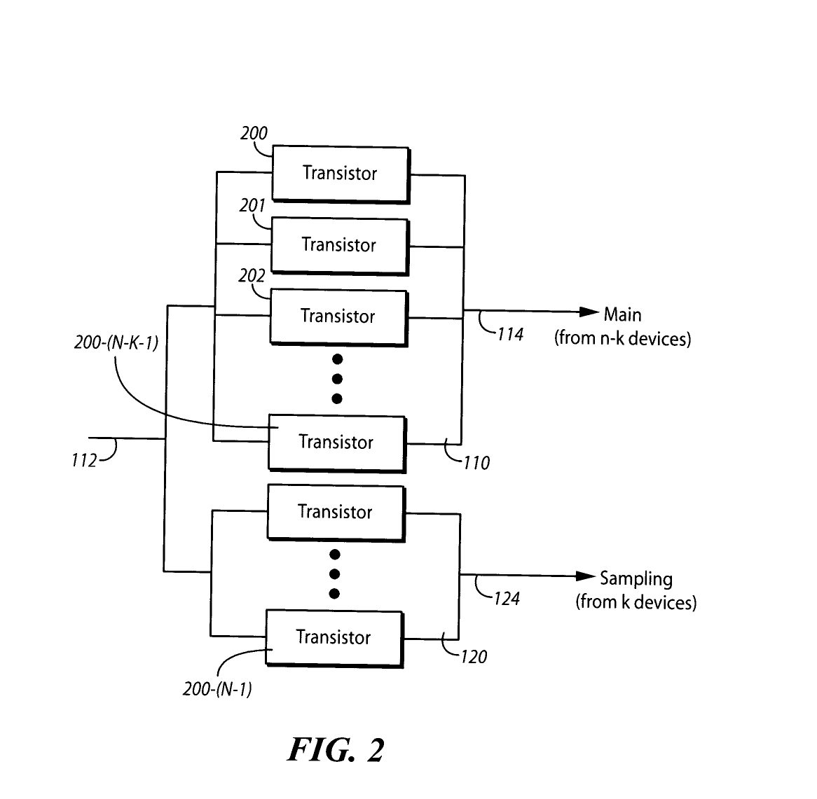

Referring now to FIG. 2, each transistor 200, 201, . . . 200-(N−1) in the network receives an identical input from the digitized radio frequency signal 112, such that the circuit can be considered to be two parallel amplifiers 110, 120 with a common input. All of the collectors of the (N-K) transistors in the first PA are coupled together to provide a common output signal 114, and likewise, all of the collectors of the K transistors in the second PA 120 are coupled together to provide a common output signal 124. Since the number of transistors in the two PAs are unequal, this arrangement provides the magnitude of the second output signal that is X times the magnitude of the first output signal, wherein X is a real number less than 1. Thus, the first output signal 114 is the main signal that is fed to the antenna, and the second output signal 124 is a substantially smaller signal that is used as a feedback signal to control the circuit. The power ratio R is defined as the ratio of the output powers of the first amplifier 110 and the second amplifier 120:

$$R = \frac{{P}_{( k )}}{{P}_{( n - k )}} = \frac{{P}_{sampling}}{{P}_{main}}$$

Since all the transistors, and therefore, both amplifiers, are biased equally with a common input, any performance variation from temperature, bias, and component/process variations will affect them uniformly. This means that the power ratio R will remain constant despite variations in temperature, bias, or other environmental or process factors which may affect the main amplifier output power level. The output signal from the K transistors will track the output signal of (N-K) devices, making it an ideal feedback signal for the control circuit. Further information pertaining to methods of creating and arranging transistor arrays may be found in U.S. Pat. Nos. 5,608,353 and 5,629,648 which are incorporated herein by reference.

Referring once again to FIGS. 1 and 3, the second output signal 124 is routed to a log-detector circuit 130 that converts the second output signal to a direct current (DC) signal that is logarithmically proportional to the second output signal. This is accomplished by means of a log amplifier 132 whose output signal is a logarithmic function of the input signal 124. Optionally, the log-detector circuit 130 further contains a DC rectifier 134 that converts the second output signal 124 to a full-wave rectified log-linear DC signal. The converted DC signal is fed into a comparison circuit which outputs a control signal. The comparison circuit compares the control signal 140 to a “set” signal, and the output of the comparison circuit is a function of the difference between the “set” signal and the control signal. This signal is then fed to the first and second power amplifiers 110, 120 to control the output of both power amplifiers, to insure that the power ratio R remains constant. In one embodiment, a filtering circuit 136 removes any high frequency components of the DC signal. In certain situations, the difference in gain between the transistor arrays in the first and second power amplifiers will vary as the bias condition changes, especially if the control dynamic range of the power amplifier is large. For example, for one bias setting, the difference in the output of the two amplifiers might be X, whereas for another bias setting, the difference in the outputs might be X+Y, where Y is a function of the total output power (which depends on the bias condition). An optional direct feedback loop 142 from the second amplifier to the second amplifier mitigates the magnitude of Y, to provide a consistent offset between the two amplifiers. Even if the magnitude of Y is a slow varying function, when the range of output power is large, the overall variation may be significant, and this type of feedback will mitigate the deviation X between the two amplifiers. Another way to mitigate the magnitude of Y is to add a bias dependent circuit between the output of the power control circuit and the secondary power amplifier.

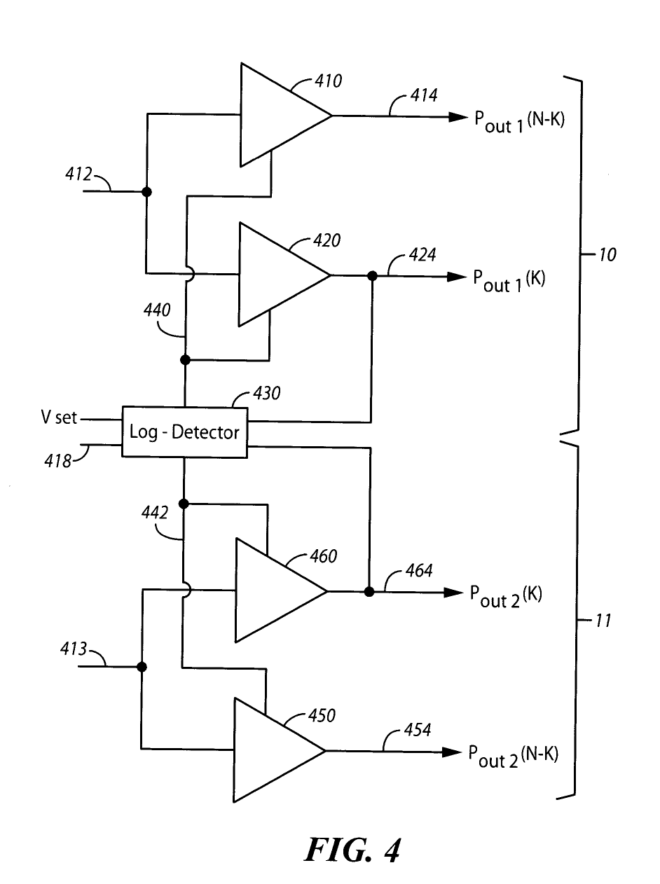

Referring now to FIG. 4, this principle can be used to control the output power of multiple radio frequency power detecting circuits 10, 11. For example, in a dual-band PA module operating at two frequencies, such as GSM (Global System for Mobile Communications) and DCS/PCS frequencies, there are two different radio frequency signals 412, 413 that need to be amplified. The dual-band PA module contains two sets of radio frequency power detectors configured as previously described. A first radio frequency power detecting circuit 10 contains a first power amplifier 410 that is situated to receive a first radio frequency signal 412 and amplify the signal to provide an output signal 414. A second power amplifier 420 is situated to also receive the signal 412 and to provide a sampling signal 424 that is less than the output signal 414. A second radio frequency power detecting circuit 11 contains a third power amplifier 450 situated to receive the other radio frequency signal 413 and amplify it to provide a third output signal 454. A fourth power amplifier 460 is also situated to receive the other radio frequency signal 413 and to provide a sampling signal 464 that is less than the third output signal 454. A selector signal 418 from the mobile wireless device indicates to the log detector 430 which of the two input signals 412 or 413 need to be amplified. The log-detector 430, responsive to the selector signal 418, determines which sampling signal 424 or 464 will be used to create an output signal 440, 442 that is then fed back to the respective operating power amplifiers 410, 420, 450, 460. The selector signal 418 determines whether to take Pₒᵤₜ1(k) or Pₒᵤₜ2(k) and use it to control (i.e. convert to a logarithmically proportional DC signal, representative of the output power). Thus, one can have multiple power detecting circuits, each comprised of its own main and secondary or sampling transistor arrays, which feed back their respective sample signals, and depending on which frequency band is in operation, a controller will select the appropriate input and control its power. Of course, the number of power detecting circuits does not need to be limited to two, and the select signal will accordingly be such that it can pick one power detecting circuit among many to operate at one time.

Thus, at least four factors contribute to achieving improved performance of the power amplifier despite variations in operating temperature and manufacturing process variations: 1) coupling two transistor networks to a single RF input, 2) using a secondary transistor network to sample and track a main transistor network, 3) placing all the components on a single semiconductor die so as to mitigate thermal and manufacturing process variations, and 4) feeding back the sample signal to control the main PA. Converting the second output signal into a logarithmic signal improves the dynamic range of the radio frequency power detecting circuit. When the magnitude of the second output signal is small, minor changes in the level of the signal can be easily be confused or lost in the noise, but by converting the signal from linear to logarithmic, small changes in the lower end are magnified and can be easily detected.

In summary, without intending to limit the scope of the invention, a radio frequency power amplifier contains circuitry for detecting and precisely controlling the output power of the amplifier by sampling the output of a main amplifier and converting the sampled output to a logarithmic DC signal, then the converted DC signal is processed and fed back into the main and secondary amplifiers using the converted DC signal to feed back into the amplifiers. Those skilled in the art will recognize that the present invention has been described in terms of exemplary embodiments. However, the invention should not be so limited, since other variations will occur to those skilled in the art upon consideration of the teachings herein. While the invention has been described in conjunction with specific embodiments, only the basic architectures were illustrated for the sake of conciseness and clarity, and the embodiments illustrated herein will likely include additional components when implemented. It is evident to those skilled in the art that many alternatives, modifications, permutations and variations will become apparent in light of the foregoing description. Accordingly, it is intended that the present invention embrace all such alternatives, modifications and variations as fall within the scope of the appended claims.

1. A radio frequency power detecting circuit, comprising:
a first power amplifier situated to receive a radio frequency signal and amplify said radio frequency signal to provide a first output signal;
a second power amplifier situated to receive said radio frequency signal and to provide a second output signal that is X times the first output signal, wherein X is a real number less than 1; and
a log-detector circuit configured to convert the second output signal to a DC signal that is logarithmically proportional to the second output signal.

2. The radio frequency power detecting circuit as described in claim 1, wherein the DC signal provides feedback to control the first power amplifier.

3. The radio frequency power detecting circuit as described in claim 1, wherein the log-detector comprises circuitry for converting the second output signal to a full-wave rectified log-linear DC signal.

4. The radio frequency power detecting circuit as described in claim 1, wherein the first and second power amplifiers comprise a transistor network of N parallel transistors with a common input, wherein the first power amplifier comprises (N-K) transistors having their respective collectors coupled to provide the first output signal, and wherein the second power amplifier comprises K transistors having their respective collectors coupled to provide the second output signal, and where N and K are both integers.

5. The radio frequency power detecting circuit as described in claim 4, wherein all of the N parallel transistors in the transistor network are resident on a single semiconductor die.

6. The radio frequency power detecting circuit as described in claim 4, wherein bias is provided from a bias network equally to each of the N parallel transistors.

7. The radio frequency power detecting circuit as described in claim 4, wherein the radio frequency signal is applied equally to the N parallel transistors in the first and second power amplifiers.

8. The radio frequency power detecting circuit as described in claim 1, further comprising a filtering circuit to filter the DC signal sufficient to remove high frequency portions of the DC signal.

9. The radio frequency power detecting circuit as described in claim 1, wherein the first power amplifier is a multistage power amplifier.

10. The radio frequency power detecting circuit as described in claim 1, wherein the second power amplifier is parallel to a final stage of the first power amplifier.

11. A radio frequency power detecting circuit, comprising:
a first power amplifier having (N-K) coupled transistors, situated to receive and amplify a radio frequency signal to provide a first output signal;
a second power amplifier having K coupled transistors, situated to receive said radio frequency signal to provide a second output signal that is X times the first output signal in magnitude, wherein X is a real number less than 1;
a log-detector circuit configured to convert the second output signal to a full-wave rectified log-linear DC signal that is logarithmically proportional to the second output signal; and
wherein the log-detector circuit further comprises a bias output for controlling both the first and second power amplifiers.

12. The radio frequency power detecting circuit as described in claim 11, further comprising a comparison circuit, responsive to an external set signal, for comparing the external set signal to the full-wave rectified log-linear DC signal to create a bias output to the first and second power amplifiers.

13. The radio frequency power detecting circuit as described in claim 11, wherein the second power amplifier is responsive to a feedback signal output from the second power amplifier.

14. The radio frequency power detecting circuit as described in claim 11, wherein all of the (N-K) coupled transistors and all of the K coupled transistors are resident on a single semiconductor die.

15. The radio frequency power detecting circuit as described in claim 11, further comprising a filtering circuit to filter the DC signal sufficient to remove high frequency portions of the DC signal.

16. A method of detecting and controlling radio frequency power output, comprising:
providing a radio frequency signal to a first amplifier and to a second amplifier;
the first amplifier amplifying the radio frequency signal to provide a first output signal;
the second amplifier providing a second output signal that is X times the first output signal in magnitude, wherein X is a real number less than 1; and
converting the second output signal into a DC signal that is logarithmically proportional to the second output signal.

17. The method of detecting and controlling power output as described in claim 16, wherein the step of converting comprises converting using a log-detector.

18. The method of detecting and controlling power output as described in claim 16, further comprising a step of filtering the DC signal sufficient to remove radio frequency portions of the signal.

19. The method of detecting and controlling power output as described in claim 16, wherein the DC signal is logarithmically proportional to the first output signal.

20. The method of detecting and controlling power output as described in claim 16, further comprising a step of providing a bias from the log-detector to the first and second amplifiers.

21. The method of detecting and controlling power output as described in claim 16, further comprising a step of controlling the output power of the first and second amplifiers, wherein the first and second amplifiers are responsive to the DC signal after processing.

22. A radio frequency power detecting module having two or more radio frequency power detecting circuits, comprising:
a first radio frequency power detecting circuit comprising a first power amplifier situated to receive a first radio frequency signal and amplify said first radio frequency signal to provide a first output signal, a second power amplifier situated to receive said first radio frequency signal and to provide a sampling signal that is less than the first output signal;
a second radio frequency power detecting circuit comprising a third power amplifier situated to receive a second radio frequency signal and amplify said second radio frequency signal to provide a third output signal, a fourth power amplifier situated to receive said second radio frequency signal and to provide a sampling signal that is less than the third output signal;
a log-detector circuit, responsive to a selector signal, configured to convert respective sampling signals from either the first or the second radio frequency power detecting circuits to a logarithmically proportional DC signal, and wherein the selector signal indicates whether to convert the sampling signal from the first or the second radio frequency power detecting circuits.

23. The radio frequency power detecting module as described in claim 22, wherein the first radio frequency power detecting circuit, the second radio frequency power detecting circuit, and the log-detector circuit are all resident on a single semiconductor die.

24. The radio frequency power detecting module as described in claim 22, wherein the module comprises more than two radio frequency power detecting circuits.
